(19) United States
(12) Patent Application Publication
(10) Pub. No.: US 2013/0059118 A1
(43) Pub. Date: Mar. 7, 2013

(54) FLEXIBLE SUBSTRATE STRUCTURE AND METHOD OF FABRICATING THE SAME

(71) Applicants: Yung-Hui Yeh, Hsinchu City (TW); Chun-Cheng Cheng, Hsinchu City (TW); Chyi-Ming Leu, Hsinchu County (TW); Yung-Lung Tseng, Hsinchu County (TW)

(72) Inventors: Yung-Hui Yeh, Hsinchu City (TW); Chun-Cheng Cheng, Hsinchu City (TW); Chyi-Ming Leu, Hsinchu County (TW); Yung-Lung Tseng, Hsinchu County (TW)

(73) Assignee: INDUSTRIAL TECHNOLOGY RESEARCH INSTITUTE, Hsinchu (TW)

(21) Appl. No.: 13/306,949

(22) Filed: Nov. 29, 2011

(30) Foreign Application Priority Data
Sep. 1, 2011 (TW) 100131528

(51) Int. Cl. B32B 3/00; B32B 37/12; B32B 38/10; B32B 37/14

(52) U.S. Cl. 428/141; 156/60; 156/250

(57) ABSTRACT

A flexible substrate structure including a flexible metal carrier, a surface-modified layer and a flexible plastic substrate is provided. The flexible metal carrier includes a first region and a second region. The surface-modified layer is located on and contacts with the first region of the flexible metal carrier. The flexible plastic substrate is located over the first region and the second region. The flexible plastic substrate over the first region contacts with the surface-modified layer. The flexible plastic substrate over the second region contacts with the flexible metal carrier.

### CROSS-REFERENCE TO RELATED APPLICATION

This application claims the priority benefit of Taiwan application serial no. 100131528, filed on Sep. 1, 2011. The entirety of the above-mentioned patent application is hereby incorporated by reference herein and made a part of this specification.

### BACKGROUND

1. Technical Field

The disclosure relates to a substrate structure and a method of fabricating the same, in particular, to a flexible substrate structure and a method of fabricating the same.

2. Related Art

A roll-to-roll continuous process is superior in low cost of fab construction and large-area productions, is quite suitable for application in a thin film transistor (TFT) array process, and has competitive edge over a sheet-to-sheet process of silicon semiconductor used nowadays.

Currently, a substrate employed in a general roll-to-roll continuous process is a flexible plastic substrate, such as polyethylene terephthalate (PET) or polyethylene naphthalate (PEN), polyimide (PI), and the forms of the product are mainly single-layer patterning of an indium tin oxide (ITO) thin film or single-layer patterning of a multi-layer thin film. To fabricate and develop electronic components, a photolithography process of more than two layers must be employed. However, the flexible plastic substrate will be seriously deformed due to membrane stress in the process and reel tension of the equipment, thereby causing a large error in alignment precision of photolithography of layers above the second one, so that it is difficult to fabricate the electronic components.

### SUMMARY

The disclosure is directed to a flexible substrate structure, which is capable of significantly reducing the alignment errors among layers subsequently formed in photolithography and accomplishing a patterning process of more than two layers (including two layers).

A flexible substrate structure is introduced herein, which includes a flexible metal carrier, a surface-modified layer and a flexible plastic substrate. The flexible metal carrier includes a first region and a second region. The surface-modified layer is located on and contacts with the first region of the flexible metal carrier. The flexible plastic substrate is located over the first region and the second region. The flexible plastic substrate over the first region contacts with the surface-modified layer. The flexible plastic substrate over the second region contacts with the flexible metal carrier.

A method of fabricating a flexible substrate structure is further introduced herein, which includes: providing a flexible metal carrier including at least one first region and at least one second region; forming a surface-modified layer on the first region of the flexible metal carrier; and forming a flexible plastic substrate over the first region and the second region of the flexible metal carrier, in which the flexible plastic substrate over the first region contacts with the surface-modified layer, and the flexible plastic substrate over the second region contacts with the flexible metal carrier.

The flexible substrate structure according to the disclosure can greatly improve the alignment precision among layers subsequently formed in photolithography and increase the yield of the process.

In the method of fabricating a flexible substrate structure according to the disclosure, a simple and rapid method can be used for fabrication, and in the removal of the flexible plastic substrate, the flexible plastic substrate only needs to be cut longitudinally to the surface-modified layer, so that the flexible plastic substrates over the first regions can be separated from the surface-modified layers on the flexible plastic substrates.

Several exemplary embodiments accompanied with drawings are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view of a flexible substrate structure according to an embodiment of the disclosure.

FIG. 2 is a top view of a flexible substrate structure according to an embodiment of the disclosure.

FIG. 3 is a top view of another flexible substrate structure according to an embodiment of the disclosure.

FIG. 4 is a top view of a still another flexible substrate structure according to an embodiment of the disclosure.

FIGS. 5A to 5C illustrate a separation mechanism of electronic components using the aforementioned flexible substrate structure according to the disclosure.

### DETAILED DESCRIPTION OF DISCLOSED EMBODIMENTS

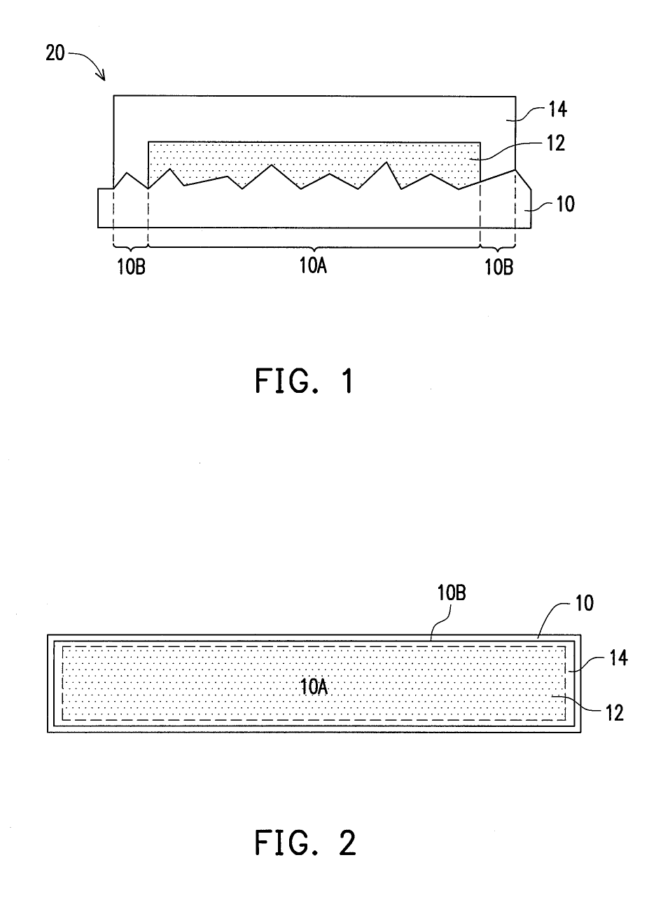

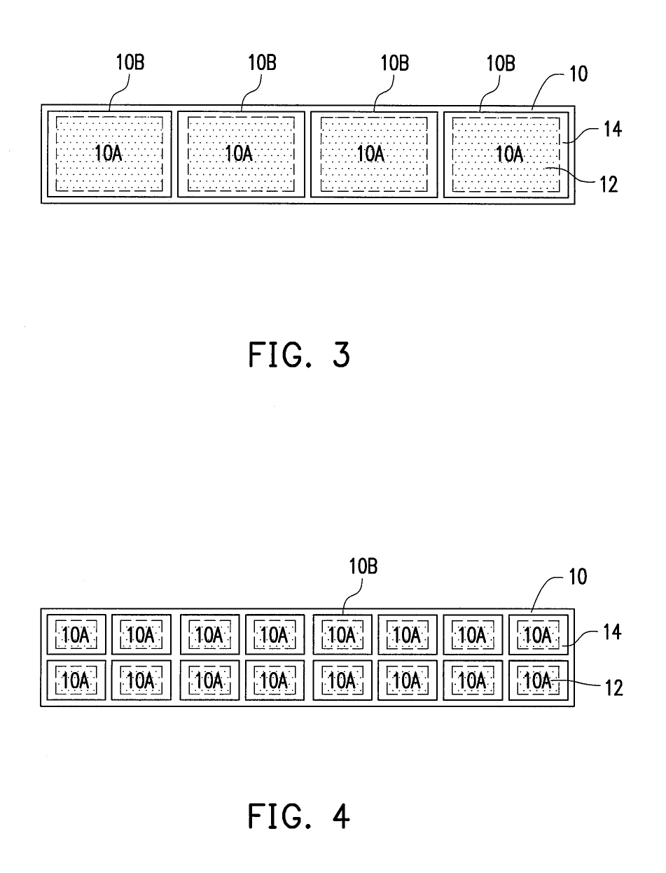

FIG. 1 is a schematic cross-sectional view of a flexible substrate structure according to an embodiment of the disclosure. FIG. 2 is a top view of a flexible substrate structure according to an embodiment of the disclosure. FIG. 3 is a top view of a flexible substrate structure according to another embodiment of the disclosure. FIG. 4 is a top view of a flexible substrate structure according to a still another embodiment of the disclosure.

Referring to FIG. 1, a flexible substrate structure 20 according to the disclosure includes a flexible metal carrier 10, a surface-modified layer 12 and a flexible plastic substrate 14.

The flexible metal carrier 10 includes a first region 10A and a second region 10B. The second region 10B is located around the first region 10A, and the region over the first region 10A is, for example, used for forming flexible electronic components, and the region over the second region 10B is, for example, a peripheral region of the flexible electronic components. Referring to FIG. 2, in an embodiment, the flexible metal carrier 10 includes a single first region 10A and a single second region 10B, and the second region 10B surrounds the first region 10A. Referring to FIGS. 3 and 4, in other embodiments, the flexible metal carrier 10 includes a plurality of first regions 10A and a plurality of second regions 10B, and each second region 10B surrounds each first region 10A. The plurality of first regions 10A of the flexible metal carrier 10 in FIG. 3 is in a single column. The plurality of first regions 10A of the flexible metal carrier 10 in FIG. 4 is in a plurality of columns. In practical application, the first region 10A may be designed to have various sizes and configurations according to actual product requirements, and is not limited to those in the above. A material of the flexible metal carrier 10 is, for example, a metal foil, and a thickness of the flexible metal carrier is between 50 μm and 200 μm. A material of the metal foil includes stainless steel or metal alloy. The first region 10A and the second region 10B of the flexible metal carrier 10 both have a rough surface. The first region 10A of the flexible metal carrier 10 has a rough surface, which can increase an adhesion of the surface-modified layer 12 to the flexible metal carrier 10; and the second region 10B of the flexible metal carrier 10 has a rough surface, which can increase an adhesion of the flexible plastic substrate 14 to the flexible metal carrier 10. In an embodiment, a roughness of the flexible metal carrier 10 is greater than 10 nm, for example, 10 nm to 500 nm.

The surface-modified layer 12 is located on and contacts with the first region 10A of the flexible metal carrier 10. A process of forming the surface-modified layer 12 may be regarded as a process of planarizing the first region 10A of the flexible metal carrier 10. A roughness of the formed surface-modified layer 12 is smaller than the roughness of the flexible metal carrier 10. In an embodiment, the roughness of the surface-modified layer 12 is smaller than 10 nm, for example, 1 nm to 10 nm. The adhesion of the surface-modified layer 12 to the flexible metal carrier 10 is greater than an adhesion of the flexible plastic substrate 14 to the surface-modified layer 12. The adhesion of the surface-modified layer 12 to the flexible metal carrier 10 is, for example, 1 B to 5 B, in which B is an adhesion unit referring to ASTM (American Standard Test Method) D339. A material of the surface-modified layer 12 includes silicone epoxy, polyimide (pyromellitic dianhydride-diaminodiphenyl ether) (PI(PMDA-ODA)) or Teflon. A thickness of the surface-modified layer 12 is, for example, 1 to 10 μm. The surface-modified layer 12 may be formed by various known coating methods, for example, dip coating, spin coating, roll coating or spray coating. The surface-modified layer 12 may be formed on the first region 10A shown in FIG. 2, FIG. 3 or FIG. 4. Since the material of the carrier 10 is metal, during the coating of the surface-modified layer 12, the surface-modified layer 12 will not be seriously deformed by the reel tension of the equipment and the resulting membrane stress, and thus the surface-modified layer 12 may be formed by a roll-to-roll method and has sufficient alignment precision in the subsequent photolithography process. However, the method of forming the surface-modified layer 12 is not limited to the roll-to-roll method, and may also be a sheet-to-sheet method or any other suitable method. In the embodiment shown in FIG. 2, the surface-modified layer 12 may be formed by a roll-to-roll continuous coating process. In the embodiments shown in FIGS. 3 and 4, the surface-modified layer 12 may be formed by a roll-to-roll discontinuous coating process.

The flexible plastic substrate 14 is located over the first region 10A and the second region 10B. The flexible plastic substrate 14 over the first region 10A contacts with the surface-modified layer 12, and the flexible plastic substrate 14 over the second region 10B contacts with the flexible metal carrier 10. The adhesion of the flexible plastic substrate 14 to the surface-modified layer 12 is smaller than the adhesion of the surface-modified layer 12 to the flexible metal carrier 10, and the adhesion of the flexible plastic substrate 14 to the flexible metal carrier 10 is greater than the adhesion of the flexible plastic substrate 14 to the surface-modified layer 12. In an embodiment, the adhesion of the flexible plastic substrate 14 to the surface-modified layer 12 is smaller than the adhesion of the surface-modified layer 12 to the flexible metal carrier 10 by 1 B to 5 B, and the adhesion of the flexible plastic substrate 14 to the flexible metal carrier 10 is greater than the adhesion of the flexible plastic substrate 14 to the surface-modified layer 12 by 1 B to 5 B. In an embodiment, the adhesion of the flexible plastic substrate 14 to the flexible metal carrier 10 is 1 B to 5 B, and the adhesion of the flexible plastic substrate 14 to the surface-modified layer 12 is 0 B. Herein, the adhesion is measured by a cross-cut adhesion test method. A material of the flexible plastic substrate 14 is, for example, polyimide (PI), polycarboxylate (PC), polyether sulfone (PES), PET, PEN, polyamide (PA), pernigraniline (PNB), polyetheretherketone (PEEK) or polyetherimide (PEI) or a combination thereof. A thickness of the flexible plastic substrate 14 is, for example, 10 μm to 200 nm. The flexible plastic substrate 14 may be formed by various known coating methods, for example, dip coating, spin coating, roll coating or spray coating. Since the material of the carrier 10 is metal, during the coating of the flexible plastic substrate 14, the flexible plastic substrate 14 will not be seriously deformed due to the reel tension of the equipment and the resulting membrane stress, and thus the flexible plastic substrate 14 may be formed by a roll-to-roll method. However, the method of forming the flexible plastic substrate 14 is not limited to the roll-to-roll method, and may also be a sheet-to-sheet method or any other suitable method. The flexible plastic substrate 14 may be formed over the first region 10A and the second region 10B shown in FIG. 2, FIG. 3 or FIG. 4. In the embodiments shown in FIG. 2, FIG. 3 and FIG. 4, the flexible plastic substrate 14 may be formed by, but not limited to, a roll-to-roll continuous coating method, and a sheet-to-sheet coating method may also be used.

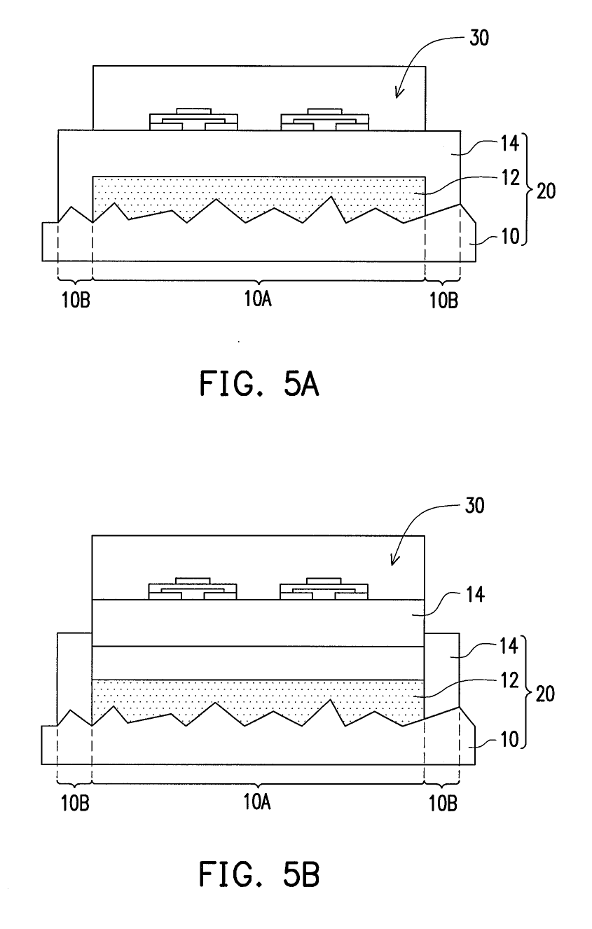

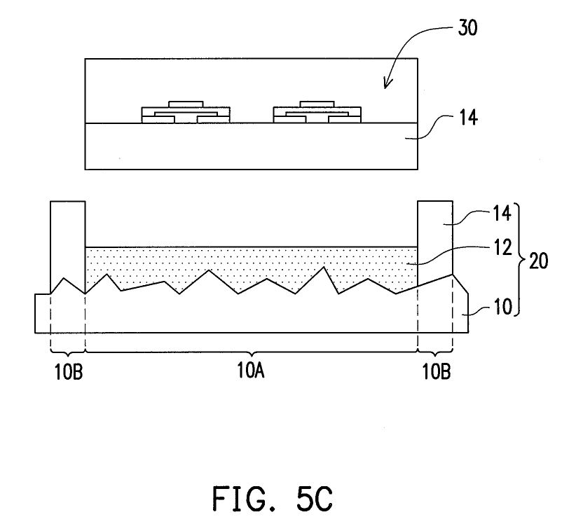

FIGS. 5A to 5C illustrate a separation mechanism of electronic components using the aforementioned flexible substrate structure according to the disclosure.

Referring to FIG. 5A, in practical application, various electronic components 30, for example, a TFT array, a passive component, a sensing component, a touch display, an electrophoretic display or an organic light emitting diode (OLED) display, may be formed over the flexible substrate structure 20.

Referring to FIG. 5B, when the flexible plastic substrate 14 over the first region 10A is cut longitudinally to the surface-modified layer 12, the flexible plastic substrate 14 over the first region 10A is separated from the surface-modified layer 12 thereon, while the flexible plastic substrate 14 over the second region 10B remains on the flexible metal carrier 10. Since the adhesion of the surface-modified layer 12 to the flexible plastic substrate 14 is quite small, for example, 0 B, a desirable separation interface is formed between the surface-modified layer 12 and the flexible plastic substrate 14. Moreover, since the flexible plastic substrate 14 has a large adhesion to the flexible metal carrier 10 for its high roughness, the flexible plastic substrate 14 can be formed and fixed on the second region 10B of the flexible metal carrier 10. Therefore, when the flexible plastic substrate 14 over the first region 10A is cut longitudinally to the surface-modified layer 12, the flexible plastic substrate 14 over the first region 10A can be automatically separated from the surface-modified layer 12 there-below, while the flexible plastic substrate 14 over the second region 10B remains on the flexible metal carrier 10. The aforementioned cutting method may be diamond knife cutting, laser cutting or mechanical cutting.

Then, referring to FIG. 5C, the flexible plastic substrate 14 that has been separated from the surface-modified layer 12 is removed from the surface-modified layer 12, and the remaining flexible metal carrier 10 may be repeatedly used.

The flexible substrate structure according to the disclosure includes a flexible metal carrier. The rigidity of metal in the flexible metal carrier can overcome the reel tension of the equipment and can reduce the deformation of subsequently formed layer or substrate. As a result, even if the subsequent layer is formed by a roll-to-roll process method, the photolithography thereof still has sufficient alignment precision, so that the lithographic alignment error is significantly reduced, and the alignment offset can be smaller than 10 μm. Therefore, a patterning process of more than two layers is accomplished, and the yield of the process is increased.

In addition, the flexible substrate structure according to the disclosure includes a surface-modified layer. The adhesion of the surface-modified layer to the flexible plastic substrate thereon is smaller than the adhesion of the surface-modified layer to the flexible metal carrier there-below, that is, an excellent separation interface exists between the surface-modified layer and the flexible plastic substrate. Therefore, when the flexible plastic substrate over the first region is cut longitudinally to the surface-modified layer, the flexible plastic substrate over the first region can be automatically separated from the surface-modified layer thereon and be removed.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A flexible substrate structure, comprising:
a flexible metal carrier, comprising a first region and a second region;
a surface-modified layer, located on and contacting with the first region of the flexible metal carrier; and
a flexible plastic substrate, located over the first region and the second region, wherein the flexible plastic substrate over the first region contacts with the surface-modified layer, and the flexible plastic substrate over the second region contacts with the flexible metal carrier.

2. The flexible substrate structure according to claim 1, wherein a surface roughness of the surface-modified layer is smaller than a roughness of the second region of the flexible metal carrier.

3. The flexible substrate structure according to claim 1, wherein an adhesion of the surface-modified layer to the flexible metal carrier is greater than an adhesion of the flexible plastic substrate to the surface-modified layer.

4. The flexible substrate structure according to claim 3, wherein the adhesion of the surface-modified layer to the flexible metal carrier is greater than the adhesion of the flexible plastic substrate to the surface-modified layer by 1 B to 5 B.

5. The flexible substrate structure according to claim 3, wherein the adhesion of the surface-modified layer to the flexible metal carrier is 1 B to 5 B.

6. The flexible substrate structure according to claim 3, wherein the adhesion of the flexible plastic substrate to the surface-modified layer is 0 B.

7. The flexible substrate structure according to claim 1, wherein an adhesion of the flexible plastic substrate to the flexible metal carrier is greater than an adhesion of the flexible plastic substrate to the surface-modified layer.

8. The flexible substrate structure according to claim 7, wherein the adhesion of the flexible plastic substrate to the flexible metal carrier is greater than the adhesion of the flexible plastic substrate to the surface-modified layer by 1 B to 5 B.

9. The flexible substrate structure according to claim 7, wherein the adhesion of the flexible plastic substrate to the flexible metal carrier is 1 B to 5 B.

10. The flexible substrate structure according to claim 7, wherein the adhesion of the flexible plastic substrate to the surface-modified layer is 0 B.

11. The flexible substrate structure according to claim 1, wherein a material of the flexible metal carrier is a metal foil, and a thickness of the flexible metal carrier is between 50 μm and 150 μm.

12. The flexible substrate structure according to claim 11, wherein a material of the metal foil comprises stainless steel or metal alloy.

13. The flexible substrate structure according to claim 1, wherein a thickness of the flexible plastic substrate is 10 μm to 200 μm.

14. The flexible substrate structure according to claim 1, wherein a material of the flexible plastic substrate is polyimide (PI), polycarboxylate (PC), polyether sulfone (PES), polyethylene terephthalate (PET), polyethylene naphthalate (PEN), polyamide (PA), pernigraniline (PNB), polyetheretherketone (PEEK) or polyetherimide (PEI).

15. The flexible substrate structure according to claim 1, wherein a material of the surface-modified layer comprises silicone epoxy, polyimide (pyromellitic dianhydride-diaminodiphenyl ether) (PI(PMDA-ODA)) or Teflon.

16-22. (canceled)
